(19) United States
(12) Patent Application Publication
(10) Pub. No.: US 2023/0356975 A1
(43) Pub. Date: Nov. 9, 2023

(54) METHOD AND SYSTEM FOR USING DIGITAL TWINS FOR DETERMINING NEED FOR MAINTENANCE OF AN ELEVATOR

(71) Applicant: KONE Corporation, Helsinki (FI)

(72) Inventors: Otto PEKANDER, Helsinki (FI); Matti LAAKSO, Helsinki (FI); Olli MALI, Helsinki (FI); Mari ZAKRZEWSKI, Helsinki (FI)

(73) Assignee: KONE Corporation, Helsinki (FI)

(21) Appl. No.: 18/222,050

(22) Filed: Jul. 14, 2023

Related U.S. Application Data
(63) Continuation of application No. PCT/FI2021/050205, filed on Mar. 23, 2021.

(51) Int. Cl. B66B 5/00; B66B 7/12; B66B 1/34; B64U 10/13

(52) U.S. Cl. CPC B66B 5/0025; B66B 7/1238; B66B 1/3492; B64U 10/13; B66B 7/1246; B64U 2101/26

(57) ABSTRACT

The present invention relates to a method, a system and a computer program product for detecting and/or predicting need for elevator maintenance. A first digital twin of the elevator is generated using data collected by one or more sensors of an unmanned aerial vehicle (UAV) operating within the elevator shaft. One or more threshold values are defined for parameters associated with one or more components of the elevator appearing in the first digital twin. At least one second digital twin of the elevator is generated using data collected by one of more sensors of an unmanned aerial vehicle (UAV) within the elevator shaft. Each parameter of the elevator in the at least one second digital twin is compared to the respective one or more first threshold values. A request for maintenance of the one or more components of the elevator is automatically triggered if any one of the compared parameters meets or goes beyond the respective first threshold value.

### FIELD

The present invention relates to a method, a system and a computer program product related to detecting or predicting need for maintenance of elevators. More particularly, the invention relates in determining need for maintenance of an elevator utilizing digital twins generated with help of an unmanned aerial vehicle (UAV).

### BACKGROUND

For predictive maintenance of elevators, it is important to collect data from as many components as possible. For new equipment placing small, low-cost sensors to the elevator design for collecting such data usually makes sense. However, when old equipment is to be monitored, retrofitting sensors is not usually an economically feasible option, since installation cost outweighs the benefits achieved by individual sensors. One component of the elevator that is particularly laborious in maintenance is the suspension ropes.

### DESCRIPTION OF THE RELATED ART

Patent application CN111115394 A discloses using a digital twin model of an elevator system for management and control of the elevator system. A predictive maintenance unit provides predictive analysis data for operating parameters from a simulation of the digital twin model.

Patent application US2019300334 AA discloses a method of predictively maintaining an elevator driving unit. The system collects driving information on change over time in current values and sets critical levels based on collected information. This application is silent on what is the collected information and which elements provide such information.

Patent application WO19219553 A1 discloses using a digital double of a passenger transport system (escalator) for monitoring changes and change trends in respect of the components that are tracked and assessed by means of the digital double, using calculations and simulations to extend maintenance intervals. Effects of wear-related changes and change trends are simulated on the digital double.

Patent application WO16193079 A1 discloses monitoring of an elevator system by comparing a signal pattern recorded from the elevator system and comparing this to at least one comparison data set.

Patent application US2017313332 AA discloses using a mobile platform (drone) with a sensor package (video or image) obtaining information on a component of a transportation network (vehicles traveling on railways). It collects information on the component not communicatively coupled to an information network and provides information to the network. Repair or maintenance needs are predicted based on sensor data for example based on pattern of degradation over time.

Patent application JP2017061369 A2 discloses using periodical rope tension measurements to detect whether the rope condition is abnormal.

Patent application WO20200727 A1 discloses monitoring physical state of suspension means by having markings in the suspension means. Distances between markings are detected and used to calculate elastic behavior of the suspension means.

### SUMMARY

An object is to provide a method and a computer program product so as to solve the problem of monitoring components of an elevator for enabling preventive maintenance thereof. The objects of the present invention are achieved with a method according to the characterizing portion of claim 1. The objects of the present invention are further achieved with a computer program product according to the claim 6.

The preferred embodiments of the invention are disclosed in the dependent claims.

According to a first aspect, method for detecting and/or predicting need for elevator maintenance is provided. The method comprises generating a first digital twin of the elevator using data collected by one or more sensors of an unmanned aerial vehicle (UAV) operating within the elevator shaft, defining one or more threshold values for parameters associated with one or more components of the elevator appearing in the first digital twin, generating at least one second digital twin of the elevator using data collected by one of more sensors of an unmanned aerial vehicle (UAV) within the elevator shaft, comparing each parameter of the elevator in the at least one second digital twin to the respective one or more first threshold values, and automatically triggering a request for maintenance of the one or more components of the elevator if any one of the compared parameters meets or goes beyond the respective first threshold value.

According to a second aspect, the method further comprises periodically generating a plurality of said second digital twins of the elevator, obtaining trends of parameters of one or more components of the elevator based on the first digital twin and the periodically generated plurality of second digital twins, defining one or more second threshold values for the respective trend of each parameter of the respective one or more components of the elevator, comparing each trend of parameter of the elevator to the one or more second threshold values defined for the respective trend, and automatically triggering a request for maintenance if any one of the compared trends of parameters meets or goes beyond the respective second threshold value, and/or if a predicted value of the respective trend of any one of the compared trends of parameters meets or goes beyond the respective second threshold value.

According to a third aspect, the method further comprises, before automatically triggering a request for predictive maintenance, performing a further observation by the UAV by repeating the measurement that caused said parameter to meet or to go beyond the respective first threshold value and/or that caused said trend of parameter to meet or to go beyond the respective second threshold value, and triggering the request for maintenance only if the further observation confirms that the parameter meets or goes beyond the respective first threshold value and/or that the trend of parameter meets of goes beyond the respective second threshold value.

According to a fourth aspect, the sensors of the UAV comprise at least one of imaging sensor, a radar, a sound sensor and a temperature sensor. The sensors are used for estimating ageing and/or wear and/or fault of at least component of the elevator by using the imaging sensor for detecting at least one of building up of dirt, an oil leakage, lubrication status of a component, level of lubrication substance in an oil reservoir or an oil receptable, a measurement of a component, a deformation of a component, a deformation of a surface, a colour change of a component, and a landing position accuracy of an elevator car and/or using the radar for at least one of detecting a deformation of a component and a vibration of a component during operation of the elevator, and/or using the sound sensor for detecting a change in frequency and/or amplitude of sound generated by a component, and/or using the temperature sensor for detecting a change of temperature of a component with respect to ambient temperature within the shaft and/or with respect to a reference operating temperature of the component in normal condition.

According to a fifth aspect, the UAV comprises an imaging sensor, and the imaging sensor is used for obtaining data for obtaining parameters for determining at least one of: length of at least one thimble rod spring or a length correlating with the length of the at least one thimble rod spring, wherein the first threshold and/or the second threshold is a minimum or maximum value of the respective length, length of at least two thimble rod springs or lengths correlating with lengths of the at least two thimble rod springs, wherein the first threshold and/or the second threshold is a maximum allowed difference between the respective lengths, a position of a counterweight of the elevator with respect to at least one buffer while the counterweight is at its lowest position within the shaft, wherein the first threshold and/or the second threshold is a distance between the counterweight and the respective at least one buffer, and/or a position of the elevator car with respect to at least one buffer while the elevator car is at its lowest position within the shaft, wherein the first threshold and/or the second threshold is a minimum allowed distance between the elevator car and the respective at least one buffer. Meeting or going beyond the respective maximum length and/or the maximum allowed difference and/or the minimum allowed distance used as the first threshold and/or the second threshold triggers a request for rope maintenance.

According to a sixth aspect, an/the imaging sensor of the UAV is used for obtaining data for determining landing position accuracy of the elevator car with respect to an intended landing position. The method comprises defining, based on at least one image obtained by the imaging sensor of the UAV, a distance or distances between at least one predefined reference point in the structure of the elevator car and at least one predefined reference point within the shaft associated with the respective landing, and triggering a request for maintenance in response to determining that the landing position accuracy determined on basis of said distance or distances fails to fulfill a predefined criterion.

According to another aspect, a computer program product comprising computer executable instructions is provided. When the computer executable instructions are performed by a computer or a computer system, cause the computer or computer system to perform the method according to any one of the above aspects.

According to a first system aspect, a system for detecting and/or predicting need for elevator maintenance is provided. The system comprises an unmanned aerial vehicle (UAV) and a computer device or system. The UAV is configured to collect data by one or more sensors of an unmanned aerial vehicle (UAV) operating within the elevator shaft and to provide the data to the computer device or system. The computer device or system is configured to generate a first digital twin of the elevator based on the data provided by the UAV, and to define one or more threshold values for parameters associated with one or more components of the elevator appearing in the first digital twin. The UAV is subsequently configured to collect further data by one of more sensors of the unmanned aerial vehicle (UAV) within the elevator shaft. The computer device or system is further configured to generate at least one second digital twin of the elevator using said further data, to compare each parameter of the elevator in the at least one second digital twin to the respective one or more first threshold values, and to automatically trigger a request for maintenance of the one or more components of the elevator if any one of the compared parameters meets or goes beyond the respective first threshold value.

According to a second system aspect, the UAV is configured to collect said further data periodically. The computer or computer system is configured to periodically generate a plurality of said second digital twins of the elevator, to obtain trends of parameters of one or more components of the elevator based on the first digital twin and the periodically generated plurality of second digital twins, to define one or more second threshold values for the respective trend of each parameter of the respective one or more components of the elevator, to compare each trend of parameter of the elevator to the one or more second threshold values defined for the respective trend, and to automatically trigger a request for maintenance if any one of the compared trends of parameters meets or goes beyond the respective second threshold value, and/or if a predicted value of the respective trend of any one of the compared trends of parameters meets or goes beyond the respective second threshold value.

According to a third system aspect, the computer device or system is further configured, before automatically triggering a request for predictive maintenance, to cause the UAV to perform a further observation by repeating the measurement that caused said parameter to meet or to go beyond the respective first threshold value and/or that caused said trend of parameter to meet or to go beyond the respective second threshold value, and to trigger the request for maintenance only if the further observation confirms that the parameter meets or goes beyond the respective first threshold value and/or that the trend of parameter meets of goes beyond the respective second threshold value.

According to a fourth system aspect, the sensors of the UAV comprise at least one of imaging sensor, a radar, a sound sensor and a temperature sensor, and wherein data provided by the sensors is configured to be used by the computer device or system for estimating ageing and/or wear and/or fault of at least component of the elevator by detecting, based on data obtained by the imaging sensor, at least one of building up of dirt, an oil leakage, a measurement of a component, a deformation of a component, a deformation of a surface, a color change of a component and a landing position accuracy of an elevator car, and/or detecting, based on data obtained by the radar, at least one of detecting a deformation of a component and a vibration of a component during operation of the elevator, and/or detecting, based on data obtained by the sound sensor, a change in frequency and/or amplitude of sound generated by a component, and/or detecting, based on data obtained by the temperature sensor, a change of temperature of a component with respect to ambient temperature within the shaft and/or with respect to a reference operating temperature of the component in normal condition.

According to a fifth system aspect, the UAV comprises an imaging sensor, and the computer or computer system is configured to use parameters obtained based on data provided by the imaging sensor to determine at least one of the following: length of at least one thimble rod spring or a length correlating with the length of the at least one thimble rod spring, wherein the first threshold and/or the second threshold is a minimum or maximum value of the respective length, length of at least two thimble rod springs or lengths correlating with lengths of the at least two thimble rod springs, wherein the first threshold and/or the second threshold is a maximum allowed difference between the respective lengths, a position of a counterweight of the elevator with respect to at least one buffer while the counterweight is at its lowest position within the shaft, wherein the first threshold and/or the second threshold is a distance between the counterweight and the respective at least one buffer, and/or a position of the elevator car with respect to at least one buffer while the elevator car is at its lowest position within the shaft, wherein the first threshold and/or the second threshold is a minimum allowed distance between the elevator car and the respective at least one buffer. The computer device or system is configured, upon determining that at least one of the above mentioned length and position parameters meets or goes beyond the respective maximum length and/or the maximum allowed difference and/or the minimum allowed distance used as the first threshold and/or the second threshold, to trigger a request for rope maintenance.

According to a sixth system aspect, the UAV comprises an/the imaging sensor, and the computer or computer system is configured to use parameters obtained based on data provided by the imaging sensor to determine landing position accuracy of the elevator car with respect to an intended landing position by defining, based on at least one image obtained by the imaging sensor of the UAV, a distance or distances between at least one predefined reference point in the structure of the elevator car and at least one predefined reference point within the shaft associated with the respective landing, and triggering a request for maintenance in response to determining that the landing position accuracy determined on basis of said distance or distances fails to fulfill a predefined criterion.

The present invention is based on the idea of enabling predictive maintenance of an elevator based on monitoring data concerning various components of the elevator collected by an UAV. Examples are provided for predicting need for maintenance of the suspension rope(s) of the elevator.

The present invention has the advantage that it enables automating periodical collection of data that enables noticing both slow trends and rare events, while facilitating predictive maintenance to avoid unexpected service outages due to failure or one or more components of the elevator.

### BRIEF DESCRIPTION OF THE DRAWINGS

In the following the invention will be described in greater detail, in connection with preferred embodiments, with reference to the attached drawings, in which

FIG. 1 illustrates schematically an elevator shaft.

FIG. 2 illustrates schematically components of an UAV and a sensor unit.

FIG. 3 illustrates functional components of an elevator.

FIG. 4 illustrates thimble rod springs.

### DETAILED DESCRIPTION

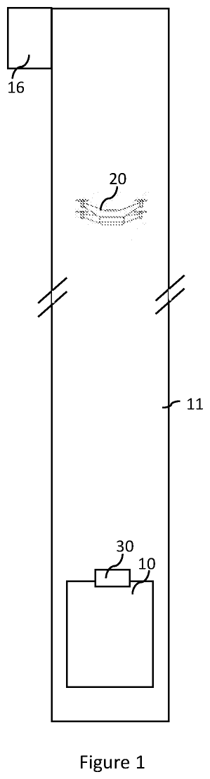

The FIG. 1 illustrates schematically an elevator shaft. The drawing is not in scale. The elevator car (10) travels in a shaft (11). An elevator controller (16) controls operation of the elevator. An unmanned aerial vehicle (UAV, 20) operates within the shaft, monitoring components of the elevator. A sensor unit (30) attached to the elevator car (10) provides status data concerning movement and position of the elevator car (10).

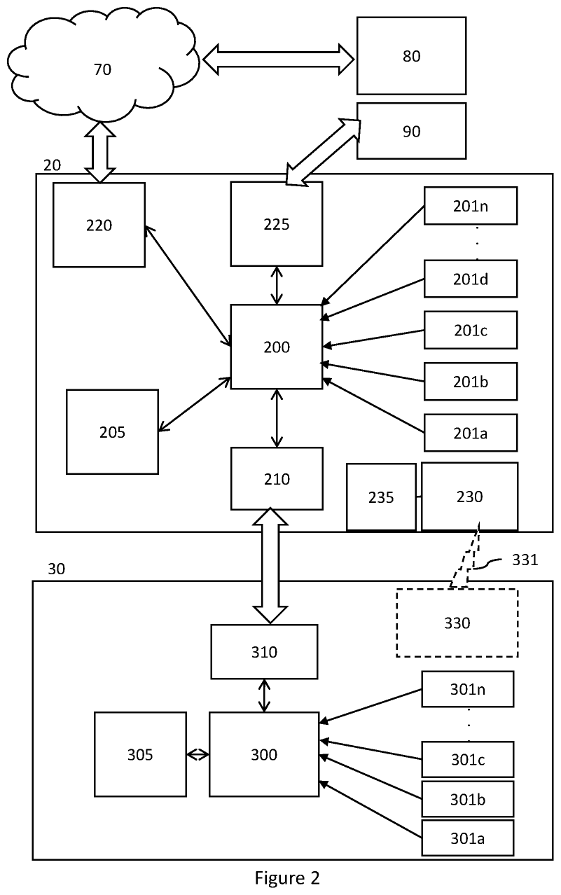

The FIG. 2 illustrates schematically components of an UAV (20) and a sensor unit (30) that facilitate operations according to the invention.

The UAV (20) comprises at least one processing device (200) that is operable for performing autonomous navigation of the UAV as well as collecting sensor information and communication. The at least one processing device (200) comprises avionics, i.e. electronic systems that control communications, navigation, display and management of various systems of the UAV. The UAV (20) is provided with a plurality of sensors (201a, 201b, 201c, 201d, . . . 201n) operatively coupled to the at least one processing device (200). The plurality of sensors comprises at least one imaging sensor (201a) like a camera, and preferably at least one of: a remote thermometer, an accelerometer, a gyroscope, a magnetometer, a lidar, a radar, a pressure sensor and a humidity sensor, or any other applicable sensor.

The at least one processing device (200) is operatively coupled to at least one memory (205) for storing computer program code that comprises computer executable instructions for the at least one processing device (200) as well as storage for at least temporarily storing information received from the sensors (201a, 201b, 201c, 201d, . . . 201n) and/or information received via communication units (210, 220) of the UAV (20). The at least one processing device (200) is further operatively coupled to a first communication unit (210) for providing communication between the UAV (20) and a sensor unit (30) attached to the elevator car. The sensor unit (30) is provided or operatively connected to wireless communication unit for enabling communication between the UAV and the sensor unit (30). The sensor unit (30) is preferably disposed at the roof of the elevator car. The sensor unit (30) may also operate as a docking station for the UAV, enabling for example charging batteries of the UAV. The first communication unit (210) may be for example a so-called short-range wireless communication unit operating according to any suitable short-range communication technology standard, including but not limited to Wireless local area network (WLAN), Bluetooth ®, Bluetooth low energy (BLE), and mesh technologies like Thread and Bluetooth Mesh. Short range wireless communication enables the docking station to interface and communicate not only with the UAV (20) but also with other components, such as internal sensors of the elevator within the shaft.

The UAV (20) may comprise a second communication unit (220) for providing second wireless communication over an external communication network (70), which may be for example a cellular network, such as a 3G, 4G or 5G cellular network or any other suitable long-range communication network. The external communication network (70) is operable for providing preferably two-way communication between the UAV (20) and one or more control and/or supervision entities (80), for example towards the elevator controller (16), which may be a dedicated elevator controlled or an elevator group controller, computing equipment of a maintenance center, maintenance equipment, monitoring equipment, an operations control center and/or like. Alternatively, the second communication unit (220) may be a short-range wireless communication device, for example a WLAN device, that provides communication towards the external communication network via a gateway device (not shown).

Either the first communication unit (210) or the second communication unit (220) or a third communication unit (225) operatively connected to the at least one processing device (200) is operable for providing communication between the UAV (20) and a remote-control unit (90) operable by a technician, for enabling manual remote control of the UAV. The FIG. 2 illustrates an option in which there is a dedicated third communication unit (225) that provides wireless connection for remote control by the remote-control unit (90). This wireless connection may be dedicated for remote control only, or it may be a two-way wireless connection that enables for example wirelessly transferring image data obtained by the imaging sensor of the UAV (20) towards a remote-control unit (90) provided with or connected to a display. Image data may refer to still images or video images.

The UAV (20) also comprises a charging unit (230) for charging at least one battery (235) of the UAV that is used for providing power for the above-mentioned functional elements of the UAV (20) as well as for operating its propellers (not shown) or other suitable means for providing thrust that enable maneuvering the UAV mid-air under control of the avionics.

A sensor unit (30) comprises communication unit (310) for communicating information with the first communication unit (210) of the UAV (20). Communication unit (310) is operatively coupled to at least one processing device (300). The sensor unit (30) is provided with a plurality of sensors (301a, 301b, 301c, . . . 301n) operatively coupled to the at least one processing device (300).

The plurality of sensors comprises at least one of a thermometer, an accelerometer, a gyroscope, a magnetometer and a pressure sensor. One of the main purposes of the sensors comprised in the sensor unit (30) is to provide real-time information on movement and/or position of the elevator car. When the sensor unit (30) is attached to the elevator car, information on position and/or movement of the sensor unit (30) can be used for determining the position and/or movement of the elevator car. The at least one processing device (300) is operatively coupled to at least one memory (305) for storing computer program code that comprises computer executable instructions for the at least one processing device (300) as well as storage for at least temporarily storing information received from the plurality of sensors (301a to 301n). The communication unit (310) provides wireless communication between the respective second communication unit (210) of the UAV (20) and the sensor unit (30). The second communication unit (210) that provides communication towards the first communication unit (210) of the UAV (20) is a short-range wireless communication device operating according to the same communication standard with the first communication unit (210).

As known in the art, a typical UAV (20) operates with electrical energy. The sensor unit (30) may be implemented as a docking station, in which case the sensor unit would typically comprise a charging station (330) for charging and re-charging (331) the at least one battery (235) of the UAV (20). However, for performing the current invention, charging station (330) is not required and thus optional, thus marked with dashed outline

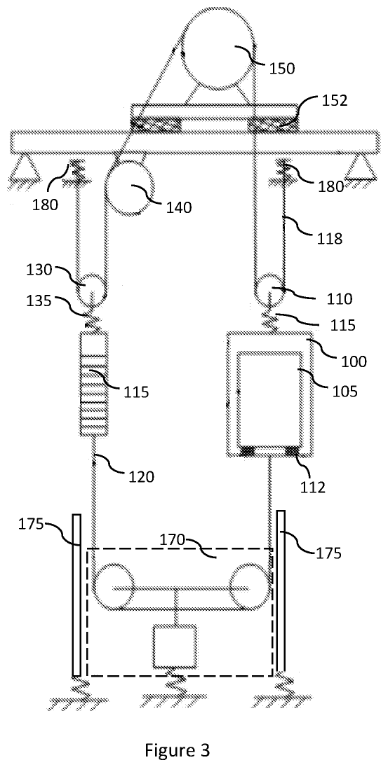

The FIG. 3 illustrates functional components of an elevator. The drawing is not in scale, and the shaft has been omitted. As known in the art, elevator designs vary significantly. This exemplary illustration is not intended as a limitation of the scope, but enables clarifying terminology used herein.

The exemplary elevator car (10) comprises a frame (100) elevator carrying a cage (105). Vibration-proof rubber (112) is used between the frame (100) and the cage (105) for dampening vibrations and thus making the cage (105) more comfortable for the passengers. One or more elevator car springs (115) attached to a elevator car sheave (110) provide coupling of the elevator car to the driving rope (118), which is one of the suspension ropes of the elevator. The driving rope is coupled to the roof of the shaft with thimble rod springs (180). A counterweight (115) is coupled to the other end of the driving rope (118) by a counterweight spring (125) and a counterweight sheave (130). A driving sheave (150) moves the elevator car and the counterweight via moving the driving rope (118). One or more guide sheaves (140) may be provided for guiding the driving rope (118). The driving sheave is typically suspended with vibration proofing elements (152) for reducing vibration of the roof of the shaft due to operation of the driving motor(s) running the driving sheave (150).

The elevator car (10), i.e. the cage (100) and the counterweight (115) are also coupled to a compensation rope (120) coupled via a tension system (170). At the bottom of the shaft, one or more buffers (175) are arranged for softening stopping of the elevator car (10) in the case the elevator car would try to run at high speed to the bottom of the shaft, and for softening stopping of the counterweight (115) in the case that the elevator car would try to run at high speed to the top of the shaft, thus also softening stopping of the elevator car (10).

In order to do predictive maintenance a drone shall be equipped at least with a temperature sensor and with an imaging sensor. The temperature sensor may be for example an infrared (IR) remote thermometer, and/or a thermal camera can be also used. Other useful sensors for monitoring are a magnetometer, a radar and a sound sensor, such as a microphone and sound detecting circuitry. Radar may be used for example for detecting movement of components when the UAV itself is stationary.

Initially, the UAV maps the elevator using at least its own sensors to generate a first digital twin, as known in the art, for using the first digital twin as a baseline for subsequent measurements. Preferably, the UAV autonomously moves within the shaft and collects data using its sensors for generating the first digital twin upon being assigned the task to generate the digital twin. The UAV will subsequently revisit all components of the shaft, repeating the digital twin generation process preferably periodically, and on each visit, to generate a second digital twin that represents a snapshot of the then current situation. Ageing of components of the elevator appearing in the first and in the at least one second digital twin is estimated based on changes between the digital twins generated at different times.

The first and second digital twins comprise information collected with various sensors of the UAV, which may comprise at least one of an imaging sensor, a radar, a sound sensor (microphone) and a temperature sensor.

For example, an imaging sensor such as a camera can be used for visually detecting building up of dirt, oil leakages, deformation of surfaces, change of dimensions and/or color changes, each of which may indicate a change related to ageing of the respective component. A radar may be used for detecting deformation of components and/or change of dimensions of components as well as excess vibration of components during movement of the elevator. Vibration may occur for example in suspension ropes or other shaft cabling in high rise buildings, and increased vibration may indicate need for maintenance. Sound detector may be used for detecting changes in a frequency and/or amplitude of a sound emitted by a functional component of the elevator. A change in frequency and/or amplitude of sound may indicate wear or malfunction. The UAV may use temperature measurements for example with a remote infrared (IR) thermometer or like to detect temperature change of a component of the elevator. A reference temperature representing ambient temperature in the shaft may be needed for determining whether temperature of the measured component has increased. The reference temperature may be obtained from an internal reference temperature sensor of the UAV. Increased friction of mechanical components or increased resistance of electrical or electronic components typically causes increase in temperature of the respective component. Thus, increased temperature of a component can be used for predicting failure of the component early, before it fails. An increase in temperature may even accelerate the actual process towards failure of the component. With regular monitoring, a trend of temperature of any monitored component can be established and the respective component can be replaced or fixed before it actually fails.

Stress for electronic components may be modelled using a prediction of lifetime for the components. For example, an electronic component operating within a predefined temperature range may be expected to operate correctly over a predetermined number of operating cycles. Average temperature may also be utilized for determining expected component lifetime. Arrhenius equation known from chemical reactions can be also applied to electronics. It is typically assumed that based on the Arrhenius equation, a component's lifetime expectation should be halved per each 10 degree increase of the average operating temperature. If the average temperature goes beyond the normal operating temperature range, lifetime expectation may shorten even more quickly.

A data point represents result of a measurement of a physical characteristic, expressed as a value of a parameter at a point of time. When new data points are obtained, an algorithm can be used to check whether there are any data points that are not within normal range of the respective parameter. If a data point deviating from what is considered normal or what is expected is found, the UAV preferably revisits this spot and for checking if the data point is indeed correct. If the measurement is deemed to be correct and the parameter associated with a respective characteristic goes beyond a predetermined threshold or the parameter has unexpectedly changed more than a predefined threshold, a maintenance request will be triggered for a technician to review the finding.

During the review, the technician accesses at least the data that triggered the maintenance request. Data comprises for example location where the data was obtained and preferably one or more images of the component(s) of interest, either still images or video. The technician may further use manual remote control to steer the UAV to the respective position at the shaft for further analysis of the situation that lead to triggering the maintenance request.

Threshold(s) for triggering a maintenance request may be defined based on an absolute value, such as a minimum allowed value or a maximum allowed value for the respective parameter, or based on a predicted value of a trend of the parameter generated based on data points obtained by repeatedly/periodically repeated measurements of the same parameter made in the past.

For some components, data points collected may form an increasing trend. When a new digital twin is built, it is possible to define a trend for any of the measured parameters. Any known trend fitting and forecasting methodology may be used for providing the forecast. For example, a trend of speed of length change of the suspension ropes can be calculated based on plurality of repeatedly or periodically measured data points to obtain a trend that gives a prediction on when the suspension ropes will need to be changed due to stretching of the suspension ropes.

In the following, we give some non-limiting examples on monitoring different components of the elevator using the UAV.

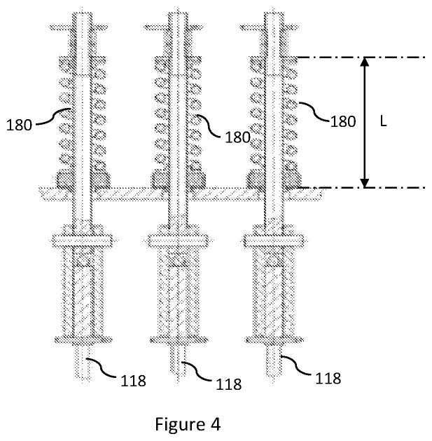

FIG. 4 illustrates an exemplary assembly of thimble rod springs (118) that are used for attaching the suspension ropes (118) at the top of the elevator shaft.

According to one exemplary embodiment, condition of the suspension ropes (118) can be monitored by monitoring the elevator thimble rod springs (180). When the suspension rope is wearing off, it is stretching, which causes a change in the thimble rod spring's (180) length (L). The length (L) may alternatively be defined based on any applicable dimension of the thimble rod structure that changes length in response to change in the thimble rod spring (180). Thus, suspension rope condition can be monitored by periodically obtaining image data of the thimble rod springs (180) and measuring the length (L) correlating with length of each respective thimble rod spring (180) based on the obtained image data and detecting a trend in change of these lengths (L). A typical elevator has more than one thimble rod spring (180). For determining need for replacing the elevator car cable, a threshold may be provided for maximum allowed length difference between different thimble rod springs (180), and/or a threshold or thresholds for maximum/minimum length (L) associated with any individual thimble rod spring. When any one of the thimble rod springs (180) hits or goes beyond any one of the defined thresholds, a request for rope maintenance is triggered.

According to a second exemplary embodiment, condition of the suspension ropes can be monitored by monitoring position of the counterweight with respect to one or more buffers (175) arranged at the bottom of the elevator shaft. As known in the art, buffers are arranged at the bottom of the elevator shaft with purpose that if the elevator car would run to the bottom of the shaft at full speed, the buffers will soften the stop. Likewise, when the elevator car would run to the top of the shaft with full speed, the buffers will soften the stop by stopping the counterweight(s) softly.

When the elevator car is at its highest point within the shaft, the counterweight is respectively at its lowest position. If the counterweight (115) starts to be very close to the buffers (175) when the elevator car is in its highest position and the counterweight is respectively at its lowest position, maintenance is needed for the suspension ropes. Thus, obtaining periodically image data of the position of the counterweight, while the counterweight is in its lowest position during normal operation of the elevator, allows forecasting when maintenance of the suspension ropes is needed and the rope maintenance, which typically is a big operation. This way, the maintenance can be planned in advance so that it can be performed at a time when elevator is not in heavy use. Thresholds that are used for triggering maintenance request should preferably be set so that the maintenance request is triggered in advance, i.e. before the maintenance is immediately necessary.

According to a third exemplary embodiment, position of the elevator car is monitored with respect to the buffers. When the trend indicates that the distance between the elevator car is becoming too short, when the elevator car it is in its lowest position within the shaft, it is time to trigger a request for rope maintenance.

The above-mentioned exemplary embodiments to detect need for maintenance of the ropes can be used either separately or in combination.

According to another example, image data may be utilized to supervise lubrication of guide rails. The imaging sensor may be used for detecting reflection of light from the guide rails, which provides an indication of lubrication status of the guide rails. Variation in amount of light reflected by the guide rails gives an indication of lubrication status thereof; whether there is sufficient amount of lubrication substance and whether the lubrication substance is evenly distributed. The imaging sensor may also be used for determining amount of lubrication substance in a reservoir within the shaft.

Images obtained by the imaging sensor of the UAV may also be used for detecting landing position accuracy of the elevator and triggering a maintenance request if the landing position accuracy fails to fulfill preset criteria. Upon stopping the elevator car on a landing, the imaging sensor of the UAV may be oriented towards the door within the shaft. For ensuring repeatable measurements, images should preferably be obtained by the UAV positioned very accurately. Such accuracy of positioning of the UAV can be obtained, for example, by landing the UAV at a specific position on the roof of the elevator car or on a landing pad at the roof of the elevator car. Typically, the door has a frame or some other objects which are visible behind the structure of the elevator car at the landing. One or more reference points in the image obtained when the elevator car has stopped at a floor may be selected as one or more reference spots of the respective floor, and the one or more reference spots are thereafter used for calculating position of the elevator car. At least one respective reference points is defined that is part of the elevator car. At least one distance between the reference points at the shaft and the elevator car is defined on basis of the obtained image or images. Such measurement information obtained on basis of the images at different times may also be included in the respective digital twins. A maintenance request is triggered if the landing position accuracy fails to fulfill a predefined criterion. For example, the landing position accuracy can be calculated as difference or variance of the distance to the intended stopping position from a mean value of the same distance detected on basis of the images obtained by the UAV's imaging sensor and/or the digital twins.

Such accurate calculation of position of the elevator car can only be achieved if angles form the obtained images can be converted into a reading of distance, preferably in millimeter scale accuracy. By ensuring, for example by mutually fitted construction of a landing pad and landing gear of the UAV, that the UAV is placed in a well-known position on the landing pad, accuracy of measurements made on basis of the image obtained by the UAV's imaging sensor can be ensured. Image-based measurement of landing positioning accuracy can be further improved by augmenting it with other measurements capable of range finding, such as lidar or radar measurements.

It is apparent to a person skilled in the art that as technology advanced, the basic idea of the invention can be implemented in various ways. The invention and its embodiments are therefore not restricted to the above examples, but they may vary within the scope of the claims.

1. A method for detecting and/or predicting need for elevator maintenance, characterized by:
generating a first digital twin of the elevator using data collected by one or more sensors of an unmanned aerial vehicle (UAV) operating with an elevator shaft;
defining one or more threshold values for parameters associated with one or more components of the elevator appearing in the first digital twin;
generating at least one second digital twin of the elevator using data collected by one of more sensors of an unmanned aerial vehicle (UAV) within the elevator shaft;
comparing each parameter of the elevator in the at least one second digital twin to the respective one or more first threshold values; and
automatically triggering a request for maintenance of the one or more components of the elevator if any one of the compared parameters meets or goes beyond the respective first threshold.

2. The method according to claim 1, wherein the method comprises:
periodically generating a plurality of said second digital twins of the elevator;
obtaining trends of parameters of one or more components of the elevator based on the first digital twin and the periodically generated plurality of second digital twins;
defining one or more second threshold values for the respective trend of each parameter of the respective one or more components of the elevator;
comparing each trend of parameter of the elevator to the one or more second threshold values defined for the respective trend; and
automatically triggering a request for maintenance if any one of the compared trends of parameters meets or goes beyond the respective second threshold value, and/or if a predicted value of the respective trend of any one of the compared trends of parameters meets or goes beyond the respective second threshold value.

3. The method according to claim 1, wherein the method comprises:
before automatically triggering a request for predictive maintenance, performing a further observation by the UAV by repeating the measurement that caused said parameter to meet or to go beyond the respective first threshold value and/or that caused said trend of parameter to meet or to go beyond the respective second threshold value, and
triggering the request for maintenance only if the further observation confirms that the parameter meets or goes beyond the respective first threshold value and/or that the trend of parameter meets of goes beyond the respective second threshold value.

4. The method according to claim 1, wherein the sensors of the UAV comprise at least one of imaging sensor, a radar, a sound sensor and a temperature sensor, and wherein the sensors are used for estimating ageing and/or wear and/or fault of at least component of the elevator by
using the imaging sensor for detecting at least one of building up of dirt, an oil leakage, lubrication status of a component, level of lubrication substance in an oil reservoir or oil receptable, a measurement of a component, a deformation of a component, a deformation of a surface, a color change of a component. and a landing position accuracy of an elevator car, and/or
using the radar for at least one of detecting a deformation of a component and a vibration of a component during operation of the elevator, and/or
using the sound sensor for detecting a change in frequency and/or amplitude of sound generated by a component, and/or
using the temperature sensor for detecting a change of temperature of a component with respect to ambient temperature within the shaft and/or with respect to a reference operating temperature of the component in normal condition.

5. The method according to claim 1, wherein the UAV comprises an imaging sensor, and the imaging sensor is used for obtaining data for obtaining parameters for determining at least one of:
length of at least one thimble rod spring or a length correlating with the length of the at least one thimble rod spring, wherein the first threshold and/or the second threshold is a minimum or maximum value of the respective length;
length of at least two thimble rod springs or lengths correlating with lengths of the at least two thimble rod springs, wherein the first threshold and/or the second threshold is a maximum allowed difference between the respective lengths;
a position of a counterweight of the elevator with respect to at least one buffer while the counterweight is at its lowest position within the shaft, wherein the first threshold and/or the second threshold is a distance between the counterweight and the respective at least one buffer, and/or
a position of the elevator car with respect to at least one buffer while the elevator car is at its lowest position within the shaft, wherein the first threshold and/or the second threshold is a minimum allowed distance between the elevator car and the respective at least one buffer;
wherein meeting or going beyond the respective maximum length and/or the maximum allowed difference and/or the minimum allowed distance used as the first threshold and/or the second threshold triggers a request for rope maintenance.

6. The method according to claim 1, wherein, an/the imaging sensor of the UAV is used for obtaining data for determining landing position accuracy of the elevator car with respect to an intended landing position, wherein the method comprises:
defining, based on at least one image obtained by the imaging sensor of the UAV, a distance or distances between at least one predefined reference point in the structure of the elevator car and at least one predefined reference point within the shaft associated with the respective landing, and
triggering a request for maintenance in response to determining that the landing position accuracy determined on basis of said distance or distances fails to fulfill a predefined criterion.

7. A non-transitory computer readable medium storing a computer program product comprising computer executable instructions which, when performed by a computer or a computer system, cause the computer or computer system to perform the method according to claim 1.

8. A system for detecting and/or predicting need for elevator maintenance, the system comprising an unmanned aerial vehicle (UAV) and a computer device or system, wherein
the UAV is configured to collect data by one or more sensors of an unmanned aerial vehicle (UAV) operating within an elevator shaft and to provide the data to the computer device or system; and
the computer device or system is configured
to generate a first digital twin of the elevator based on the data provided by the UAV; and
to define one or more threshold values for parameters associated with one or more components of the elevator appearing in the first digital twin;
wherein the UAV is subsequently configured to collect further data by one of more sensors of the unmanned aerial vehicle (UAV) within the elevator shaft; and
the computer device or system is further configured:
to generate at least one second digital twin of the elevator using said further data;
to compare each parameter of the elevator in the at least one second digital twin to the respective one or more first threshold values; and
to automatically trigger a request for maintenance of the one or more components of the elevator if any one of the compared parameters meets or goes beyond the respective first threshold value.

9. The system according to claim 8, wherein the UAV is configured to collect said further data periodically, and the computer or computer system is configured:
to periodically generate a plurality of said second digital twins of the elevator;
to obtain trends of parameters of one or more components of the elevator based on the first digital twin and the periodically generated plurality of second digital twins;
to define one or more second threshold values for the respective trend of each parameter of the respective one or more components of the elevator;
to compare each trend of parameter of the elevator to the one or more second threshold values defined for the respective trend; and
to automatically trigger a request for maintenance if any one of the compared trends of parameters meets or goes beyond the respective second threshold value, and/or if a predicted value of the respective trend of any one of the compared trends of parameters meets or goes beyond the respective second threshold value.

10. The system according to claim 8, wherein the computer device or system is further configured:
before automatically triggering a request for predictive maintenance, to cause the UA NT to perform a further observation by repeating the measurement that caused said parameter to meet or to go beyond the respective first threshold value and/or that caused said trend of parameter to meet or to go beyond the respective second threshold value, and
to trigger the request for maintenance only if the further observation confirms that the parameter meets or goes beyond the respective first threshold value and/or that the trend of parameter meets of goes beyond the respective second threshold value.

11. The system according to claim 8, wherein the sensors of the UAV comprise at least one of imaging sensor, a radar, a sound sensor and a temperature sensor, and wherein data provided by the sensors is configured to be used by the computer device or system for estimating ageing and/or wear and/or fault of at least component of the elevator by
detecting, based on data obtained by the imaging sensor, at least one of building up of dirt, an oil leakage, a measurement of a component, a deformation of a component, a deformation of a surface, a color change of a component, and a landing position accuracy of an elevator car, and/or
detecting, based on data obtained by the radar, at least one f detecting a deformation of a component and a vibration of a component during operation of the elevator, and/or
detecting, based on data obtained by the sound sensor, a change in frequency and/or amplitude of sound generated by a component, and/or
detecting, based on data obtained by the temperature sensor, a change of temperature of a component with respect to ambient temperature within the shaft and/or with respect to a reference operating temperature of the component in normal condition.

12. The system according to claim 8, wherein the UAV comprises an imaging sensor, and the computer or computer system is configured to use parameters obtained based on data provided by the imaging sensor to determine at least one of the following:
length of at least one thimble rod spring or a length correlating with the length of the at least one thimble rod spring, wherein the first threshold and/or the second threshold is a minimum or maximum value of the respective length;
length of at least two thimble rod springs or lengths correlating with lengths of the at least two thimble rod springs, wherein the first threshold and/or the second threshold is a maximum allowed difference between the respective lengths;
a position of a counterweight of the elevator with respect to at least one buffer while the counterweight is at its lowest position within the shaft, wherein the first threshold and/or the second threshold is a distance between the counterweight and the respective at least one buffer; and/or
a position of the elevator car with respect to at least one buffer while the elevator car is at its lowest position will n the shaft, wherein the first threshold and/or the second threshold is a minimum allowed distance between the elevator car and the respective at least one buffer;
wherein the computer device or system is configured, upon determining, that at least one of the above mentioned length and position parameters meets or goes beyond the respective maximum length and/or the maximum allowed difference and/or the minimum allowed distance used as the first threshold and/or the second threshold, to trigger a request for rope maintenance.

13. The system according to claim 8, the UAV comprises an/the imaging sensor, and the computer or computer system is configured to use parameters obtained based on data provided by the imaging sensor to determine landing position accuracy of the elevator car with respect to an intended landing position by:
defining, based on at least one image obtained by the imaging sensor of the UAV, a distance or distances between at least one predefined reference point in the structure of the elevator car and at least one predefined reference point within the shaft associated with the respective landing, and
triggering a request for maintenance in response to determining that the landing position accuracy determined on basis of said distance or distances fails to fulfill a predefined criterion.

14. The method according to claim 2, wherein the method comprises:
before automatically triggering a request for predictive maintenance, performing a further observation by the UAV by repeating the measurement that caused said parameter to meet or to go beyond the respective first threshold value and/or that caused said trend of parameter to meet or to go beyond the respective second threshold value, and
triggering the request for maintenance only if the further observation confirms that the parameter meets or goes beyond the respective first threshold value and/or that the trend of parameter meets of goes beyond the respective second threshold value.

15. The method according to claim 2, wherein the sensors of the UAV comprise at least one of imaging sensor, a radar, a sound sensor and a temperature sensor, and wherein the sensors are used for estimating ageing and/or wear and/or fault of at least component of the elevator by
using the imaging sensor for detecting at least one of building up of dirt, an oil leakage, lubrication status of a component level of lubrication substance in an oil reservoir or oil receptable, a measurement of a component, a deformation of a component, a deformation of a surface, a color change of a component, and a landing position accuracy of an elevator car, and/or
using the radar for at least one of detecting a dorm/nation of a component and a vibration of a component during operation of the elevator, and/or
using the sound sensor for detecting a change in frequency and/or amplitude of sound generated by a component, and/or
using the temperature sensor for detecting a change of temperature of a component with respect to ambient temperature within the shaft and/or with respect to a reference operating temperature of the component in normal condition.

16. The method according to claim 2, wherein the UAV comprises an imaging sensor, and the imaging sensor is used for obtaining data for obtaining parameters for determining at least one of:
length of at least one thimble rod spring or a length correlating with the length of the at least one thimble rod spring, wherein the first threshold and/or the second threshold is a minimum or maximum value of the respective length;
length of at least two thimble rod springs or lengths correlating with lengths of the at least two thimble rod springs, wherein the first threshold and/or the second threshold is a maximum allowed difference between the respective lengths;
a position of a counterweight of the elevator with respect to at least one buffer while the counterweight is at its lowest position within the shaft, wherein the first threshold and/or the second threshold is a distance between the counterweight and the respective at least one buffer; and/or
a position of the elevator car with respect to at least one buffer while the elevator car is at its lowest position within the shaft, wherein the first threshold and/or the second threshold is a minimum allowed distance between the elevator car and the respective at least one buffer;
wherein meeting or going beyond the respective maximum length and/or the maximum allowed difference and/or the minimum allowed distance used as the first threshold and/or the second threshold triggers a request for rope maintenance,

17. The method according to claim 2, wherein an/the imaging sensor of the is used for obtaining data for determining landing position accuracy of the elevator car with respect to an intended landing position, wherein the method comprises:
defining, based on at least one image obtained by the imaging sensor of the UAV, a distance or distances between at least one predefined reference point in the structure of the elevator car and at least one predefined reference point within the shaft associated with the respective landing, and
triggering a request for maintenance in response to determining that the landing, position accuracy determined on basis of said distance or distances fails to fulfill a predefined criterion.

18. A computer program product comprising computer executable instructions which, when performed by a computer or a computer system, cause the computer or computer system to perform the method according to claim 2.

19. The system according to claim 9, therein the computer device or system is further configured:
before automatically triggering a request for predictive maintenance, to cause the UAV to perform a further observation by repeating the measurement that caused said parameter to meet or to go beyond the respective first threshold value and/or that caused said trend of parameter to meet or to go beyond the respective second threshold value, and
to trigger the request for maintenance only if the further observation co s that the parameter meets or goes beyond the respective first threshold value and/or that the trend of parameter meets of goes beyond the respective second threshold value.

20. The system according to claim 9, wherein the sensors of the UAV comprise at least one of imaging sensor, a radar, a sound sensor and a temperature sensor, wherein data provided, by the sensors is configured to be used by the computer device or system for estimating ageing, and/or wear and/or fault of at least component of the elevator by
detecting, based on data obtained by the imaging sensor, at least one of building up of dirt, an oil leakage, a measurement of a component, a deformation of a component, a deformation of a surface, a color change of a component, and a landing position accuracy of an elevator car, and/or
detecting, based on data obtained by the radar, at least one of detecting a deformation of a component and a vibration of a component during operation of the elevator, and/or
detecting, based on data obtained by the sound sensor, a change in frequency and/or amplitude of sound generated by a component, and/or
detecting, based on data obtained by the temperature sensor, a change of temperature of a component with respect to ambient temperature within the shaft and/or with respect to a reference operating temperature of the component in normal condition.
